(19) United States
(12) Patent Application Publication
(10) Pub. No.: US 2017/0045856 A1
(43) Pub. Date: Feb. 16, 2017

(54) DRIVING-FORCE TRANSMITTING DEVICE AND IMAGE FORMING APPARATUS

(71) Applicant: FUJI XEROX CO., LTD., Tokyo (JP)

(72) Inventors: Jun KAWAI, Kanagawa (JP); Takayuki KONDO, Kanagawa (JP); Zentaro NEMOTO, Kanagawa (JP); Masami SAKURAI, Kanagawa (JP)

(73) Assignee: FUJI XEROX CO., LTD., Tokyo (JP)

(21) Appl. No.: 15/049,770

(22) Filed: Feb. 22, 2016

(30) Foreign Application Priority Data
Aug. 12, 2015 (JP) 2015-159554

(51) Int. Cl. G03G 15/00; F16D 1/10; F16D 3/205; F16D 1/02

(52) U.S. Cl. CPC G03G 15/757; F16D 1/02; F16D 1/10; F16D 3/205; F16D 2001/103

(57) ABSTRACT

A driving-force transmitting device includes a first driving joint portion that receives a driving force from a drive source and transmits the driving force to a first rotatable body to rotate the first rotatable body; and a second driving joint portion that receives a driving force from a drive source and transmits the driving force to a second rotatable body to rotate the second rotatable body. The first driving joint portion includes a pair of involute spline joints including an external gear and an internal gear. The second driving joint portion includes a universal joint that changes a position at which the driving force is transmitted in accordance with a position of an axis of the second rotatable body.

### CROSS-REFERENCE TO RELATED APPLICATIONS

This application is based on and claims priority under 35 USC 119 from Japanese Patent Application No. 2015-159554 filed Aug. 12, 2015.

### BACKGROUND

### Technical Field

The present invention relates to a driving-force transmitting device and an image forming apparatus.

### SUMMARY

According to an aspect of the invention, there is provided a driving-force transmitting device including a first driving joint portion that receives a driving force from a drive source and transmits the driving force to a first rotatable body to rotate the first rotatable body; and a second driving joint portion that receives a driving force from a drive source and transmits the driving force to a second rotatable body to rotate the second rotatable body. The first driving joint portion includes a pair of involute spline joints including an external gear and an internal gear. The second driving joint portion includes a universal joint that changes a position at which the driving force is transmitted in accordance with a position of an axis of the second rotatable body.

### BRIEF DESCRIPTION OF THE DRAWINGS

An exemplary embodiment of the present invention will be described in detail based on the following figures, wherein:

FIG. 1 is a schematic sectional view illustrating the internal structure of an image forming apparatus;

FIG. 2A is a perspective view of a driving-force transmitting device viewed from a driving-force transmission side, and FIG. 2B is a perspective view of the driving-force transmitting device viewed from a driving-source side;

FIG. 3 is a schematic sectional view illustrating how a photoconductor unit and a developing device are attached;

FIGS. 4A and 4B are perspective views of an external gear and an internal gear, respectively, which form a pair of involute spline joints;

FIG. 5 is a sectional view illustrating the rotational-driving-force transmission between a first driving joint portion and a photoconductor drum;

FIGS. 6A and 6B are schematic sectional views illustrating an alignment function of the first driving joint portion;

FIGS. 7A and 7B are a perspective view and a schematic sectional view, respectively, of a universal joint, and FIG. 7C is a schematic sectional view of a developing roller gear;

FIG. 8 is a schematic sectional view illustrating the manner in which a rotational driving force is transmitted to a developing roller; and

FIG. 9 is a schematic sectional view illustrating the manner in which rotational driving forces are transmitted to a photoconductor drum and the developing roller.

### DETAILED DESCRIPTION

The present invention will be explained in further detail by describing an exemplary embodiment and examples with reference to the drawings. However, the present invention is not limited to the exemplary embodiment and examples.

It is to be noted that the drawings referred to in the following description are schematic, and that dimensional ratios, for example, are not equal to the actual dimensional ratios. Components other than those needed to be explained to facilitate understanding are omitted as appropriate in the drawings.

To facilitate understanding of the following description, in the drawings, the front-rear direction is defined as the X-axis direction, the left-right direction is defined as the Y-axis direction, and the up-down direction is defined as the Z-axis direction.

### 1. Overall Structure and Operation of Image Forming Apparatus

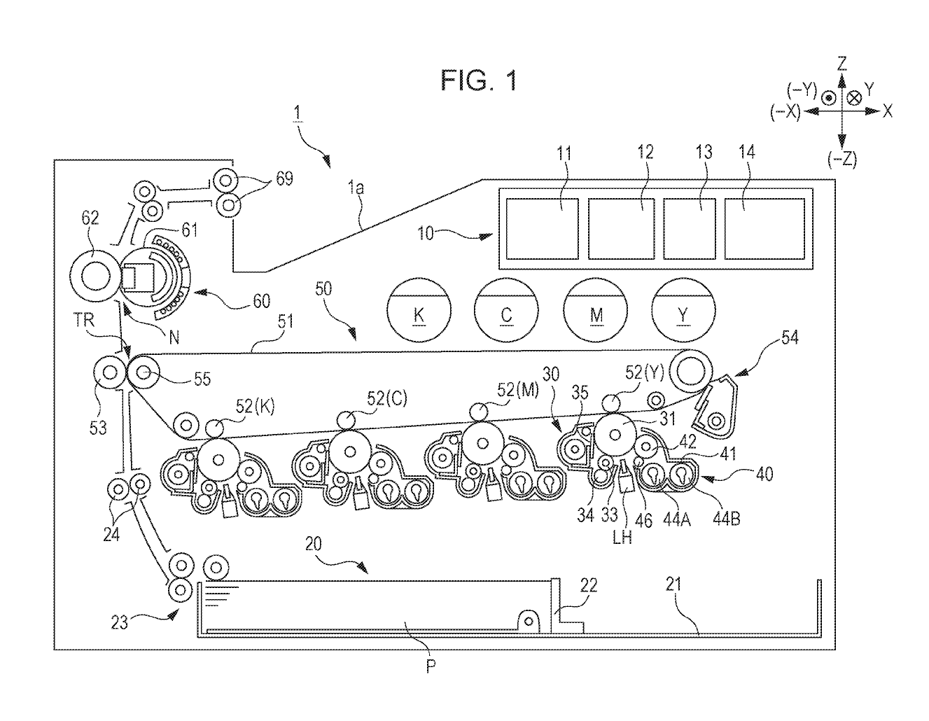

FIG. 1 is a schematic sectional view illustrating the internal structure of an image forming apparatus 1 including a driving-force transmitting device 100 according to an exemplary embodiment.

The overall structure and operation of the image forming apparatus 1 will be described with reference to FIG. 1.

The image forming apparatus 1 includes a control device 10, a sheet feeding device 20, photoconductor units 30, developing devices 40, a transfer device 50, and a fixing device 60. An output tray 1a, which receives sheets having images recorded thereon, is provided on the top surface (Z-direction-side surface) of the image forming apparatus 1.

The control device 10 includes an image-forming-apparatus controller 11 that controls the operation of the image forming apparatus 1; a controller unit 12 that prepares image data corresponding to a print request; an exposure controller 13 that controls the on-off state of exposure devices LH; and a power supply device 14. The power supply device 14 applies a high voltage to, for example, charging rollers 33, developing rollers 42, first transfer rollers 52, and a second transfer roller 53, which will be described below, and supplies electric power to, for example, the exposure devices LH, the sheet feeding device 20, the fixing device 60, and various sensors.

The controller unit 12 converts print information input thereto from an external information transmission device (for example, a personal computer) into image information used to form a latent image, and outputs drive signals to the exposure devices LH at a preset timing. Each of the exposure devices LH according to the present exemplary embodiment includes an LED head in which plural light emitting diodes (LEDs) are linearly arranged in a scanning direction.

The sheet feeding device 20 is provided in a lower section of the image forming apparatus 1. The sheet feeding device 20 includes a sheet stacking plate 21, and multiple sheets P, which serve as recording media, are stacked on the top surface of the sheet stacking plate 21. The sheets P stacked on the sheet stacking plate 21 are positioned in the width direction by a restricting plate 22. The sheets P are drawn one at a time from the top toward the front side (in the −X direction) by a sheet-drawing unit 23, and then are transported to a nip portion of a pair of registration rollers 24.

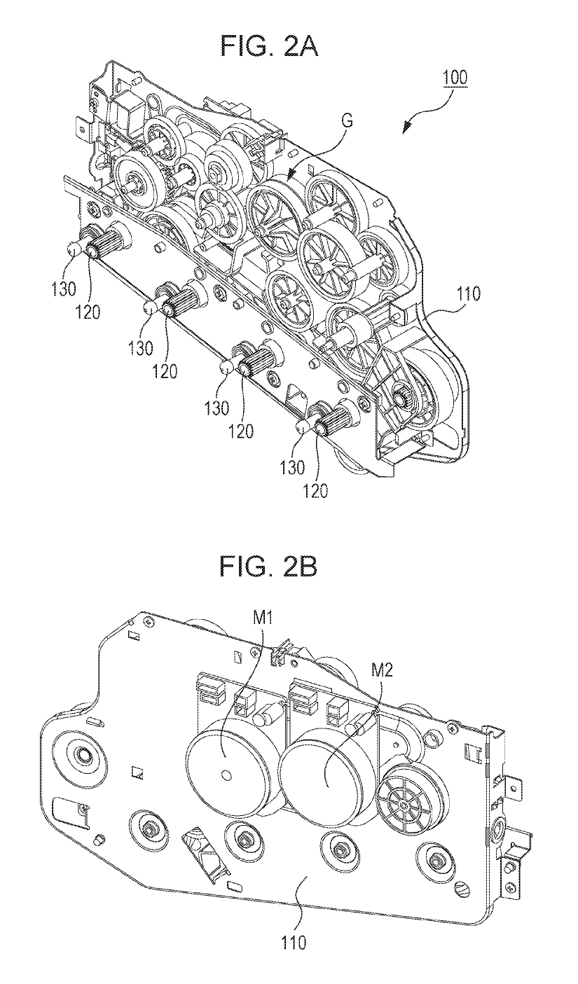

The photoconductor units 30 are arranged next to each other above (on the Z-direction side of) the sheet feeding device 20. Each photoconductor unit 30 includes a rotatable photoconductor drum 31 that is rotated by the driving-force transmitting device 100 (see FIGS. 2A and 2B). A charging roller 33, an exposure device LH, a developing device 40, a first transfer roller 52, and a cleaning blade 35 are arranged around the photoconductor drum 31 in that order in the rotation direction of the photoconductor drum 31. A cleaning roller 34, which cleans the surface of the charging roller 33, is arranged so as to face the charging roller 33 and be in contact with the charging roller 33.

The developing device 40 includes a developing housing 41 that contains developer. The developing housing 41 houses a developing roller 42, which is in contact with the photoconductor drum 31 and rotated by the driving-force transmitting device 100 (see FIGS. 2A and 2B), and a pair of transport augers 44A and 44B that are disposed behind and below the developing roller 42 and that stir and transport the developer toward the developing roller 42. A layer-thickness regulating member 46, which regulates the layer thickness of the developer, is disposed near the developing roller 42.

Developing devices 40 having substantially the same structure except for the color of the developer contained in the developing housing 41 are provided to form yellow (Y), magenta (M), cyan (C), and black (K) toner images.

The surface of each photoconductor drum 31 that rotates is charged by the charging roller 33, and an electrostatic latent image is formed on the surface of the photoconductor drum 31 by latent-image forming light emitted from the exposure device LH. The electrostatic latent image formed on the photoconductor drum 31 is developed into a toner image by the developing roller 42.

The transfer device 50 includes an intermediate transfer belt 51 and first transfer rollers 52. The toner images of the respective colors formed on the photoconductor drums 31 of the photoconductor units 30 are transferred onto the intermediate transfer belt 51 in a superposed manner while the intermediate transfer belt 51 is rotated by a transfer driving roller 55. The first transfer rollers 52 successively transfer the toner images of the respective colors formed in the photoconductor units 30 onto the intermediate transfer belt 51 (first transfer process). The transfer device 50 also includes a second transfer roller 53 and an intermediate-transfer-belt cleaner 54. The second transfer roller 53 simultaneously transfers the toner images of the respective colors that have been transferred onto the intermediate transfer belt 51 in a superposed manner onto a sheet P, which is a recording medium (second transfer process). The intermediate-transfer-belt cleaner 54 removes toner that remains on the intermediate transfer belt 51.

The toner images of the respective colors formed on the photoconductor drums 31 of the photoconductor units 30 are successively electrostatically transferred onto the intermediate transfer belt 51 by the first transfer rollers 52, which receive a predetermined transfer voltage from, for example, the power supply device 14 controlled by the image-forming-apparatus controller 11 (first transfer process). Thus, a superposed toner image in which the toner images of the respective colors are superposed is formed.

The intermediate transfer belt 51 is moved so that the superposed toner image on the intermediate transfer belt 51 is transported to the region in which the second transfer roller 53 is disposed (second transfer region TR). The sheet feeding device 20 supplies a sheet P to the second transfer region TR at the time when the superposed toner image reaches the second transfer region TR. The second transfer roller 53 receives a predetermined transfer voltage from, for example, the power supply device 14 controlled by the image-forming-apparatus controller 11, so that the superposed toner image on the intermediate transfer belt 51 is transferred onto the sheet P fed from the pair of registration rollers 24 and guided by a transport guide.

The toner that remains on the surface of each photoconductor drum 31 is removed by the cleaning blade 35 and collected in a waste toner container (not shown). Then, the surface of the photoconductor drum 31 is charged again by the charging roller 33. Substances that have not been removed by the cleaning blade 35 and adhered to the charging roller 33 are caught on the surface of the cleaning roller 34 that rotates while being in contact with the charging roller 33, and are accumulated.

The fixing device 60 includes a heating module 61 and a pressing module 62, and a fixing nip region N (fixing region) is formed in a region in which the heating module 61 and the pressing module 62 are pressed against each other.

The sheet P onto which the toner image has been transferred by the transfer device 50 is transported to the fixing device 60 along the transport guide in a state such that the toner image is not fixed. The sheet P transported to the fixing device 60 is pressed and heated by the pair of modules, which are the heating module 61 and the pressing module 62, so that the toner image is fixed to the sheet P.

The sheet P to which the toner image is fixed is output from a pair of output rollers 69 to the paper output tray 1a on the top surface of the image forming apparatus 1.

### 2. Driving-Force Transmitting Device

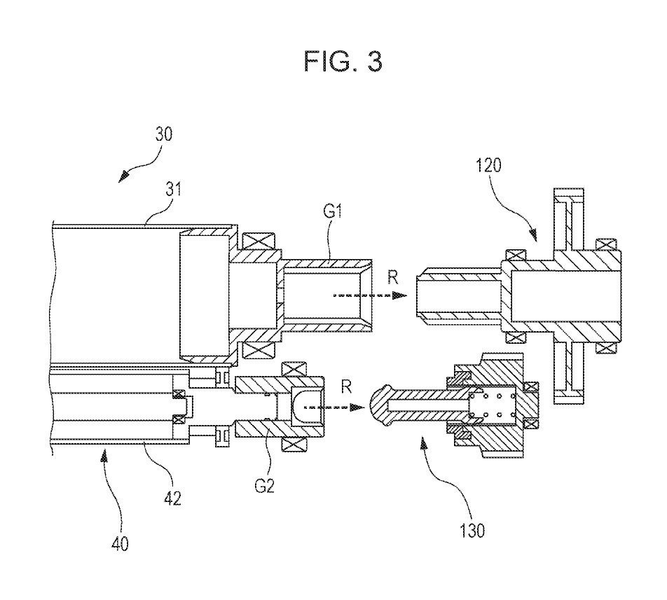

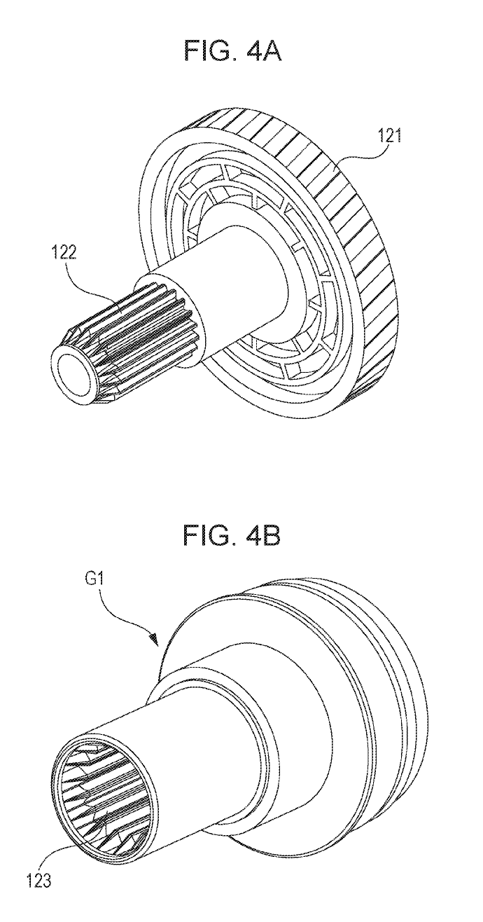

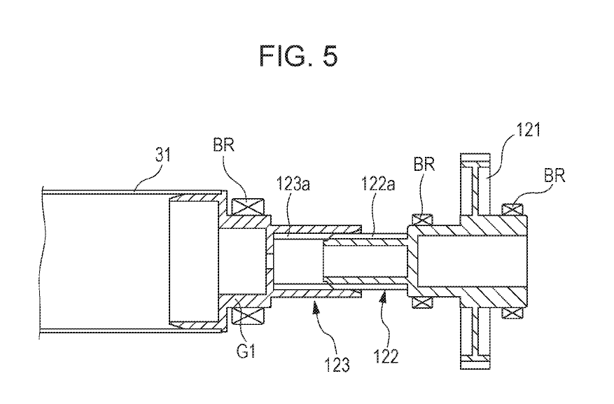

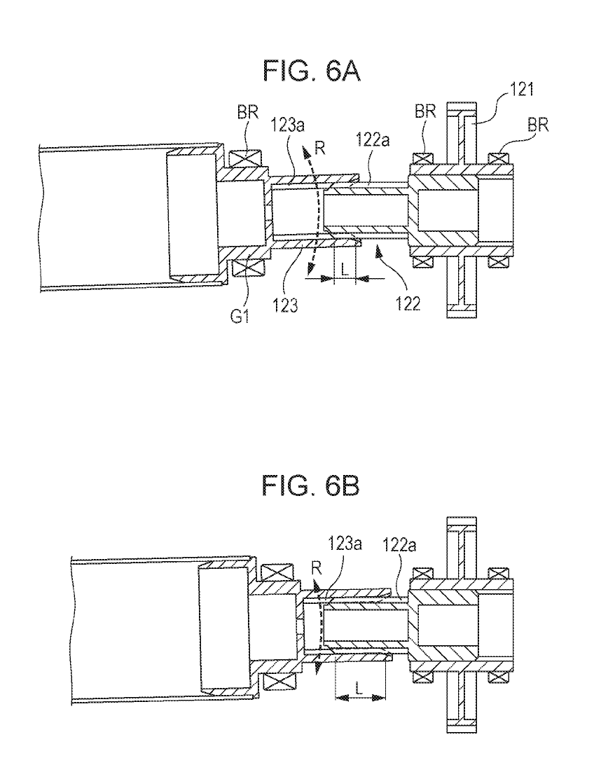

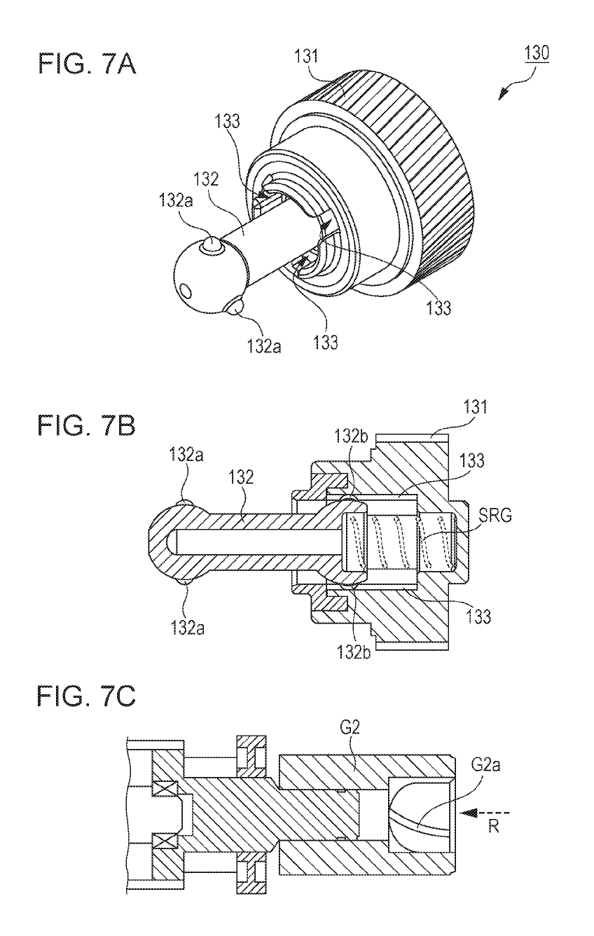

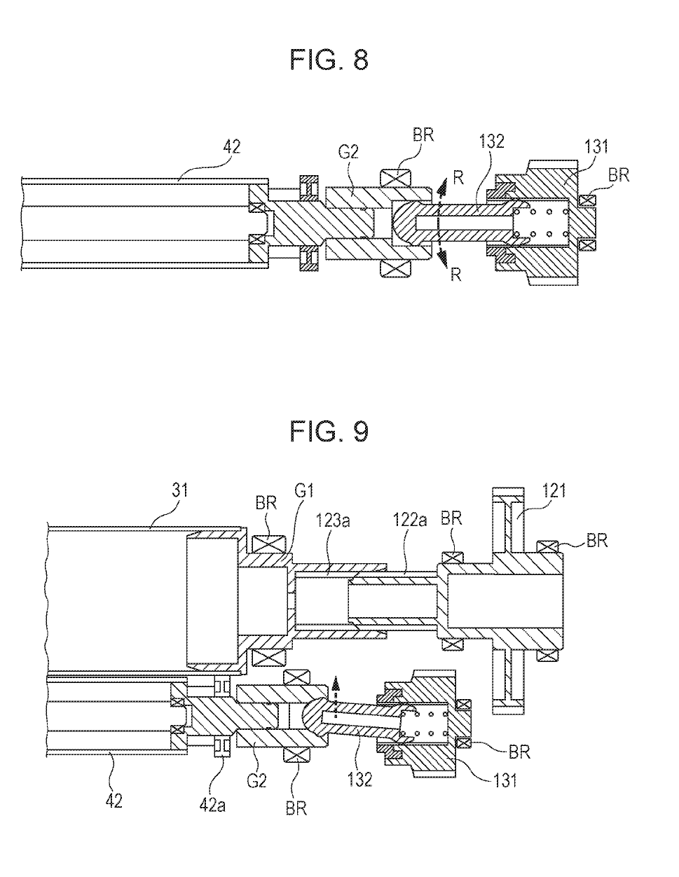

FIG. 2A is a perspective view of the driving-force transmitting device 100 viewed from a driving-force transmission side, and FIG. 2B is a perspective view of the driving-force transmitting device 100 viewed from a driving-source side. FIG. 3 is a schematic sectional view illustrating how the photoconductor unit 30 and the developing device 40 are attached. FIGS. 4A and 4B are perspective views of an external gear 122 and an internal gear 123, respectively, which form a pair of involute spline joints. FIG. 5 is a sectional view illustrating the rotational-driving-force transmission between a first driving joint portion 120 and the photoconductor drum 31. FIGS. 6A and 6B are schematic sectional views illustrating an alignment function of the first driving joint portion 120. FIGS. 7A and 7B are a perspective view and a schematic sectional view, respectively, of a universal joint, and FIG. 7C is a schematic sectional view of a developing roller gear G2. FIG. 8 is a schematic sectional view illustrating the manner in which a rotational driving force is transmitted to the developing roller 42. FIG. 9 is a schematic sectional view illustrating the manner in which rotational driving forces are transmitted to the photoconductor drum 31 and the developing roller 42.

The structure of the driving-force transmitting device 100 will now be described below with reference to the drawings.

### 2.1. Overall Structure of Driving-Force Transmitting Device

The driving-force transmitting device 100 includes a frame 110, plural gears G that transmit rotational driving forces of driving motors M1 and M2, and first and second driving joint portions 120 and 130 that transmit the rotation of the gears G to rotatable bodies.

As shown by arrows R in FIG. 3, the photoconductor unit 30 and the developing device 40 are inserted into the apparatus body along guide rails (not shown) from the front side of the apparatus body, and are connected to the driving-force transmitting device 100 so as to receive the rotational driving forces from the driving-force transmitting device 100.

As illustrated in FIG. 2A, plural first driving joint portions 120 and plural second driving joint portions 130 are supported such that the first and second driving joint portions 120 and 130 project from the frame 110 at the driving-force transmission side of the driving-force transmitting device 100.

Each first driving joint portion 120 transmits a rotational driving force of the driving motor M1, which is an example of a driving source, to the corresponding photoconductor drum 31, which is an example of a first rotatable body, and each second driving joint portion 130 transmits a rotational driving force of the driving motor M2 to the corresponding developing roller 42, which is also an example of a second rotatable body.

### 2.2. First Driving Joint Portion

As illustrated in FIG. 4A, the first driving joint portion 120 includes the first output gear 121, which is driven by the driving motor M1 through the gears G, and the external gear 122 that coaxially projects from the first output gear 121.

The external gear 122 meshes with the internal gear 123 shown in FIG. 4B that is formed in a central portion of a flange gear G1. The flange gear G1 is coaxially fixed to the photoconductor drum 31 at one end of the photoconductor drum 31. The external gear 122 transmits the rotational driving force of the driving motor M1 to the photoconductor drum 31.

As illustrated in FIG. 5, involute spline teeth 122a are formed on the outer periphery of the external gear 122. The involute spline teeth 122a mesh with involute spline teeth 123a formed on the inner periphery of the internal gear 123 of the flange gear G1, thereby forming an involute spline coupling.

The involute spline coupling has a structure that provides a high aligning performance. Accordingly, even when the axis of the flange gear G1 and the axis of the first output gear 121 are misaligned when the photoconductor unit 30 is installed in the apparatus body, the misalignment may be absorbed and the rotational driving force may be transmitted.

Referring to FIG. 5, the flange gear G1, the first output gear 121, and the external gear 122 are supported by rotational support portions BR.

FIGS. 6A and 6B illustrate the alignment function of the first driving joint portion 120. The first driving joint portion 120, which forms the involute spline coupling together with the internal gear 123 of the flange gear G1 that is coaxially fixed to the photoconductor drum 31, has a backlash (see arrow R in FIGS. 6A and 6B) in accordance with the meshing length (L in FIGS. 6A and 6B) between the involute spline teeth 122a of the external gear 122 and the involute spline teeth 123a of the internal gear 123 of the flange gear G1.

Accordingly, even when the axis of the flange gear G1 and the axis of the first driving joint portion 120 are misaligned, the misalignment may be smoothly absorbed and the rotational driving force may be transmitted.

The amount of backlash may be adjusted by appropriately setting the transfer coefficient between the involute spline teeth 122a and the involute spline teeth 123a.

As a result, even when the meshing length of the involute spline teeth 122a of the external gear 122 and the involute spline teeth 123a of the internal gear 123 of the flange gear G1 is increased, the misalignment may be absorbed by increasing the backlash, and the rotational driving force may be transmitted.

### 2.3. Second Driving Joint Portion

As illustrated in FIG. 7A, the second driving joint portion 130 includes a second output gear 131, which is driven by the driving motor M2 through the gears G, and a connecting member 132 that projects coaxially with the second output gear 131 and supported in a movable manner.

As illustrated in FIG. 8, the connecting member 132 forms a ball joint mechanism that serves as a universal joint that connects the second output gear 131 to the developing roller gear G2 fixed to the developing roller 42. The connecting member 132 smoothly transmits the rotational driving force to the developing roller 42, which is installed in the apparatus body and rotates while being in contact with the photoconductor drum 31.

Referring to FIG. 8, the developing roller gear G2 and the second output gear 131 are supported by rotational support portions BR.

As illustrated in FIGS. 7A and 7B, the connecting member 132 includes a substantially spherical distal end portion that is thicker than other portions and that includes, for example, three distal end projections 132a. The connecting member 132 also includes a substantially spherical proximal end portion that is thicker than other portions and that includes, for example, three proximal end projections 132b.

The connecting member 132 is urged toward the developing roller gear G2 of the developing roller 42 by an urging member SRG while the proximal end projections 132b are engaged with grooves 133 formed in a shaft portion of the second output gear 131, and is thereby supported so as to be movable in an axial direction.

As illustrated in FIG. 7C, grooves G2a are formed in the developing roller gear G2 so as to extend obliquely with respect to the direction in which the distal end portion of the connecting member 132 is installed. The distal end projections 132a on the distal end portion of the connecting member 132 engage with the grooves G2a so that the rotational driving force of the second output gear 131 is transmitted to the developing roller gear G2.

The direction in which the grooves G2a obliquely extend is determined so that the distal end projections 132a are pulled inward along the grooves G2a (see arrow R in FIG. 7C) when the connecting member 132 rotates, so that the connecting member 132 is prevented from being released from the developing roller gear G2.

Accordingly, the connecting member 132 is capable of being tilted relative to the second output gear 131 and the developing roller gear G2 as shown by arrow R in FIG. 8. When the axes of the developing roller gear G2 and the second output gear 131 are misaligned, an angular velocity variation occurs at the second-output-gear-131 side end of the connecting member 132 in accordance with the tilt angle of the connecting member 132. However, an angular velocity variation that cancels the angular velocity variation at the second-output-gear-131 side is generated at the developing-roller-gear-G2 side, so that the developing roller 42 rotates at a constant angular velocity.

In the driving-force transmitting device 100 having the above-described structure, even when the axis of the flange gear G1 and the axis of the first output gear 121 are misaligned when the photoconductor unit 30 is installed in the apparatus body, the misalignment may be absorbed by the first driving joint portion 120, which forms the involute spline coupling, and the rotational driving force may be transmitted.

In the case where the developing roller 42 is pressed against the photoconductor drum 31 with a contact roller 42a, there is a risk that a contact load applied to the developing roller 42 will vary.

When the contact load variation occurs, the urging force that presses the developing roller 42 against the photoconductor drum 31 varies. Therefore, there is a risk that the photoconductor drum 31 will be displaced or an angular velocity of the photoconductor drum 31 will vary.

In the driving-force transmitting device 100 according to the present exemplary embodiment, also when the axes of the developing roller gear G2 and the second output gear 131 are misaligned when the developing device 40 is attached to the apparatus body, the second driving joint portion 130 forms a ball joint mechanism as a universal joint that connects the second output gear 131 to the developing roller gear G2 fixed to the developing roller 42, so that the second output gear 131 and the developing roller gear G2 have the same angular velocity.

Thus, the angular velocity of the photoconductor drum 31 that rotates while the developing roller 42 is pressed against the photoconductor drum 31 with the contact roller 42a may be prevented from varying (see FIG. 9).

In the present exemplary embodiment, the photoconductor drums 31 are described as an example of first rotatable bodies. However, the first rotatable body that receives a rotational driving force from a driving source through each first driving joint portion 120 may instead be a pair of transport augers 44A and 44B, which are developing screws that transport the developer to the developing roller 42 while stirring the developer, or a transfer driving roller 55 that rotates the intermediate transfer belt 51.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A driving-force transmitting device comprising:
a first driving joint portion that receives a driving force from a drive source and transmits the driving force to a first rotatable body to rotate the first rotatable body; and
a second driving joint portion that receives a driving force from a drive source and transmits the driving force to a second rotatable body to rotate the second rotatable body,
wherein the first driving joint portion includes a pair of involute spline joints including an external gear and an internal gear,
wherein the second driving joint portion includes a universal joint that includes a projection that interacts with the second rotatable body and changes a position at which the driving force is transmitted in accordance with a position of an axis of the second rotatable body,
wherein the second rotatable body includes an oblique groove into which the projection engages such that the projection is pulled toward the rotatable body along the groove when the universal joint is rotated, and
wherein in response to an axis of an second output gear of the second driving joint portion and an axis of a developing roller gear of the second rotatable body being misaligned, the second driving joint portion forms a ball joint mechanism for the second output gear and the second rotatable body to have the same angular velocity.

2. The driving-force transmitting device according to claim 1, wherein the second rotatable body is supported such that the second rotatable body is movable so as to come into contact with the first rotatable body or approach the first rotatable body.

3. The driving-force transmitting device according to claim 1, wherein the internal gear included in the involute spline joints is integrated with the first rotatable body such that the internal gear is coaxial with an axis of the first rotatable body.

4. The driving-force transmitting device according to claim 1, wherein the first rotatable body is any one of a photoconductor drum, a transfer drive roller, and a developing screw that is included in a body of an image forming apparatus or detachably attached to the body of the image forming apparatus, and
wherein the second rotatable body is a developing roller.

5. The driving-force transmitting device according to claim 2, wherein the first rotatable body is any one of a photoconductor drum, a transfer drive roller, and a developing screw that is included in a body of an image forming apparatus or detachably attached to the body of the image forming apparatus, and
wherein the second rotatable body is a developing roller.

6. The driving-force transmitting device according to claim 3, wherein the first rotatable body is any one of a photoconductor drum, a transfer drive roller, and a developing screw that is included in a body of an image forming apparatus or detachably attached to the body of the image forming apparatus, and
wherein the second rotatable body is a developing roller.

7. An image forming apparatus comprising:
a driving-force transmitting device according to claim 1;
a driving motor that rotates gears included in the driving-force transmitting device; and
an image forming unit that receives a rotational driving force from the driving-force transmitting device and forms an image.

8. The driving-force transmitting device according to claim 1, wherein the first driving joint portion absorbs a misalignment of the transmitting device during an installment of the transmitting device in the image forming apparatus.

9. The driving-force transmitting device according to claim 1, wherein the second driving joint portion includes a ball joint at a distal end of the developing roller.
